(19) United States
(12) Patent Application Publication
(10) Pub. No.: US 2018/0116892 A1
(43) Pub. Date: May 3, 2018

(54) Dental Chair Cover Kit

(71) Applicant: Tatyana Kovyarenko, Palmyra, NJ (US)

(72) Inventor: Tatyana Kovyarenko, Palmyra, NJ (US)

(21) Appl. No.: 15/800,265

(22) Filed: Nov. 1, 2017

Related U.S. Application Data
(60) Provisional application No. 62/416,252, filed on Nov. 2, 2016.

(51) Int. Cl. A61G 15/10; A47C 31/11; A45F 5/00

(52) U.S. Cl. CPC A61G 15/10; A45F 2005/002; A45F 5/00; A47C 31/113

(57) ABSTRACT

A dental chair cover kit is provided. The kit includes a dental chair cover having a cover body configured to cover a portion of a back rest of a dental chair, a headrest pocket configured to receive a headrest of the dental chair, an extendable neck member interconnecting the cover body to the headrest pocket, and a bib removably affixed to the cover body. The pocket includes an interior volume sized to receive the headrest of the dental chair and an opening for providing access to the interior volume. The extendable neck member includes an accordion fold biased to a first collapsed position and extendable to a second extended position for enabling extension of the cover body relative to the headrest pocket. The bib includes a strap for removably securing the bib to a user and a slot configured to removably receive and retain an item on the bib.

### CROSS REFERENCE TO RELATED APPLICATIONS

This application claims the benefit of U.S. Provisional Application No. 62/416,252 filed on Nov. 2, 2016. The above identified patent application is herein incorporated by reference in its entirety to provide continuity of disclosure.

### BACKGROUND OF THE INVENTION

The present invention relates to dental chair covers and accessories. More specifically, the present invention relates to a dental chair cover kit including a disposable dental chair cover and a removable bib configured to provide an all-in-one kit for covering a dental chair and to provide a dentist the convenience of having an easily accessible bib in close proximity for a patient.

The majority of dental chairs are covered merely at the headrest, while the back rest of the dental chair is devoid of any covering. This leaves the back rest exposed to water and saliva during dental procedures, which creates an unsanitary environment for patients. Protective coverings used to cover the back rest or occasionally the headrest are typically made of plastic, or other non-eco-friendly or economical materials.

Current dental bibs utilize a strap including a metal clip for fastening the bib around a patient's neck. The metal clip must be disinfected after each use in order to ensure that the bib is in a sanitary condition for the patient.

Therefore, there is a need for a dental chair cover kit that includes a disposable eco-friendly and economical dental chair cover that includes a removable bib for providing a more convenient and sanitary environment for a dentist and patient.

### SUMMARY OF THE INVENTION

In view of the foregoing disadvantages inherent in the known types of dental chair covers and accessories now present in the prior art, the present invention provides a dental chair cover kit wherein the same can be utilized for providing convenience for the user when protecting a dental chair and treating a dental patient.

In one example of the present invention, the dental chair cover kit comprises a dental chair cover including a body configured to cover an upper portion of a back rest of a dental chair, a pocket configured to receive a headrest of the dental chair therein, an extendable neck member enabling extension of the body relative to the pocket, and a bib removably affixed to the dental chair cover via an adhesive material. The body includes a planar flexible member including an upper end and an upper surface. The pocket includes a closed upper end, an open lower end, an upper surface, and an interior volume sized to receive the headrest of the dental chair. The open lower end includes a perimeter edge defining an opening for providing access to the interior volume. The extendable neck member interconnects the upper end of the body to the perimeter edge of the pocket. The extendable neck member is biased in a first position and extendable to a second position. The bib includes a flexible planar member including a strap for removably securing the bib to a user and an upper surface including a slot configured to removably receive and retain an item.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded perspective view of the dental chair cover kit according to one embodiment of the present invention.

FIG. 2 shows a perspective view of the dental chair cover of the dental chair cover kit according to one embodiment of the present invention.

FIG. 3A shows a perspective view of the patient bib of the dental chair cover kit according to one embodiment of the present invention.

FIG. 3B shows a perspective view of the patient bib of the dental chair cover kit according to another embodiment of the present invention.

FIG. 3C shows a perspective view of the patient bib of the dental chair cover kit according to an alternative embodiment of the present invention.

FIG. 4 shows a perspective view of the dental chair cover kit in use according to one embodiment of the present invention.

### DETAILED DESCRIPTION OF THE INVENTION

Reference is made herein to the attached drawings. Like reference numerals are used throughout the drawings to depict like or similar elements of the dental chair cover kit. The figures are intended for representative purposes only and should not be considered to be limiting in any respect.

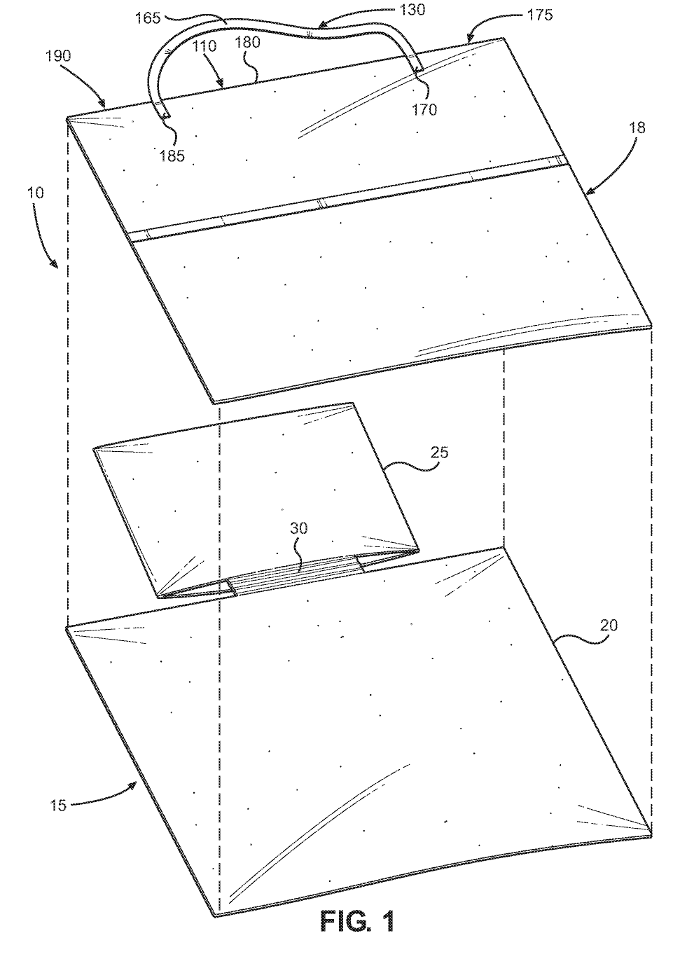

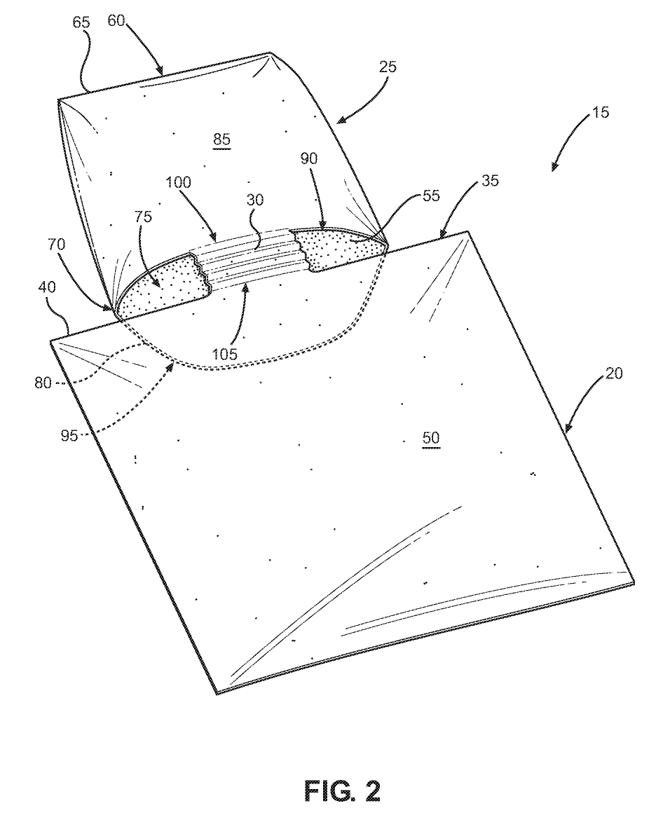

Referring now to FIGS. 1 and 2, there is shown an exploded perspective view of the dental chair cover kit according to one embodiment of the present invention and a perspective view of the dental chair cover of the dental chair cover kit according to one embodiment of the present invention, respectively. The present invention provides a dental chair cover kit 10 including a disposable dental chair cover 15 and a disposable patient bib 18 removably affixed to the dental chair cover 15 for providing a user, such as a dentist, the convenience of having an all-in-one kit including both a protective dental chair cover and an easily accessible patient bib for use during treatment of patients.

The dental chair cover 15 includes a cover body 20 configured to cover an upper portion of a back rest of a dental chair, a headrest pocket 25 configured to receive a headrest of the dental chair therein and retain the dental chair cover 15 on the dental chair, and an extendable neck member 30 configured to enable extension of the cover body 20 relative to the headrest pocket 25. In the depicted embodiment, the dental chair cover 15 is a flexible member composed of a recyclable paper material. In another embodiment, the dental chair cover 15 is composed of a plastic material, such as nonwoven polypropylene.

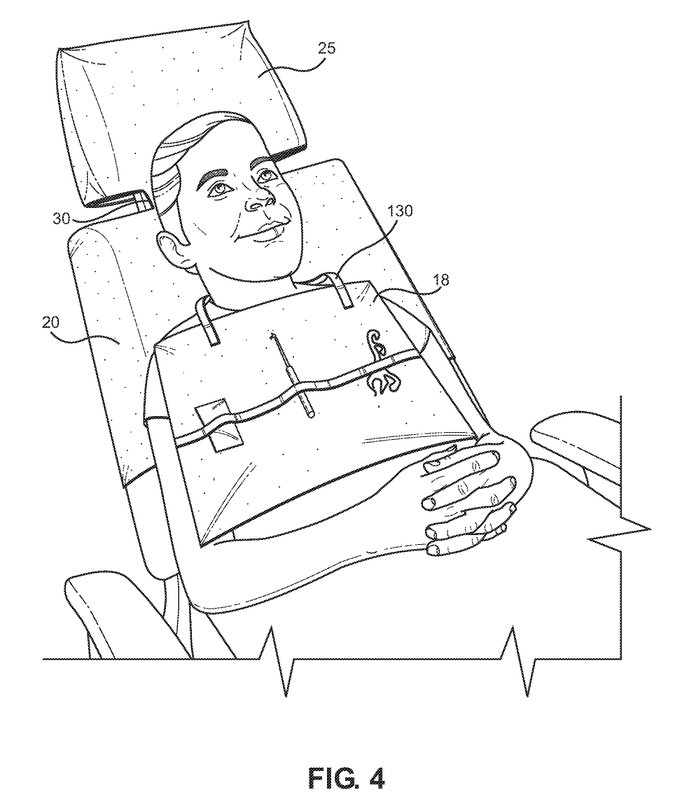

The cover body 20 includes a planar member including an upper end 35 having an edge 40, an upper surface 50, a longitudinal length, and a lateral width. In the depicted embodiment, the cover body 20 includes a rectangular planar member. However, in alternative embodiments, the cover body 20 includes alternative polygonal shapes. The cover body 20 includes a length equal to or less than half a length of a backrest of a dental chair, such that the cover body 20 covers only the upper portion of the back rest of the dental chair, as shown in FIG. 4. In this way, the cover body 20 is not obstructive, uncooperative, or awkward in any way when utilizing the dental chair cover kit 10. Further, the cover body 20 includes a width greater than or equal to the width of a backrest of the dental chair so as to shield the entire upper surface of the upper portion of the backrest of the dental chair.

The headrest pocket 25 includes an interior volume 55, a closed upper end 60 including a sewn or stitched edge 65, an open lower end 70 including an opening 75 defining a perimeter edge 80 for providing access to the interior volume 55, and an upper surface 85. The interior volume 55 is shaped and sized like a dental chair headrest and is configured to receive the dental chair headrest, as shown in FIG. 4. The perimeter edge 80 includes a first side 90 adjacent the upper surface 85 and an opposing second side 95 adjacent a rear of the headrest pocket 25.

The extendable neck member 30 includes a stretchable, flexible member including an accordion fold for extending the extendable neck member 30 in order to accommodate a dental chair in which the dental chair headrest has been extended relative to the dental chair backrest, as shown in FIG. 4. The accordion fold includes two or more parallel folds disposed in opposite directions, allowing the extendable neck member 30 to collapse onto itself into a first collapsible position, as shown in FIG. 1, and extend into a second extended position, as shown in FIG. 4.

The extendable neck member 30 includes a first end 100 affixed to the first side 90 of the perimeter edge 80 of the open lower end 70 of the headrest pocket 25, and a second end 105 affixed to the edge 40 of the upper end 35 of the cover body 20, thereby interconnecting the headrest pocket 25 to the cover body 20. The extendable neck member 30 is biased towards the first collapsed position, such that the extendable neck member 30 automatically collapses into the first collapsed position, thereby collapsing the headrest pocket 25 and cover body 15 towards one another.

In the depicted embodiment, the extendable neck member 30 interconnects the cover body 20 to the headrest pocket 25 such that the upper surface 50 of the cover body 20 and the upper surface 85 of the headrest pocket 25 are coplanar relative to each other along a longitudinal plane of the dental chair cover 15. In this way, the opening 75 of the headrest pocket 25 is disposed offset and beneath the longitudinal plane of the dental chair cover 15 and positioned such that the dental chair cover 15 can be easily donned onto a dental chair.

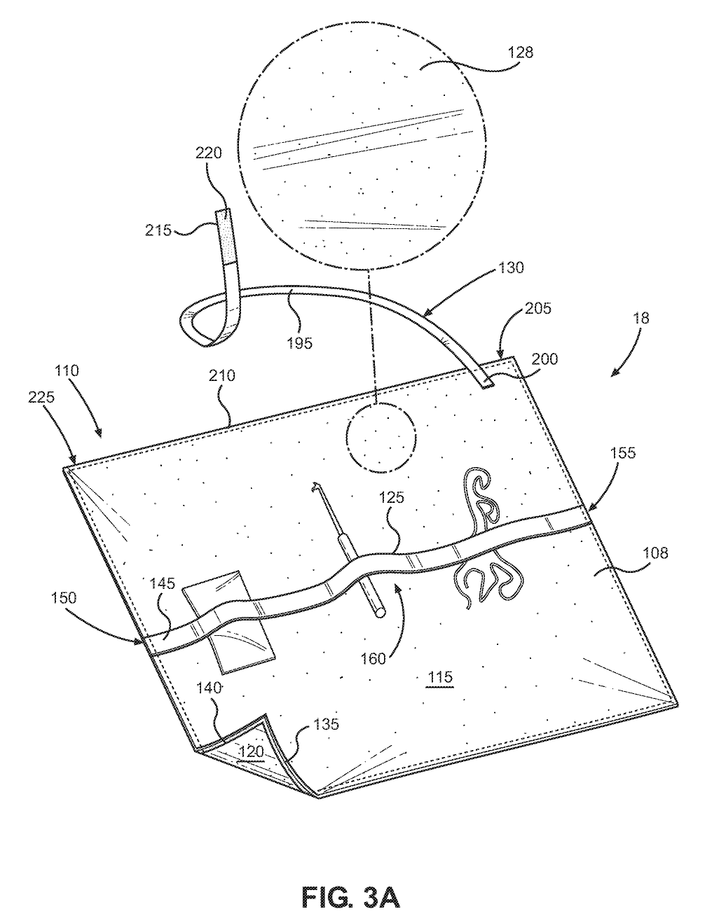

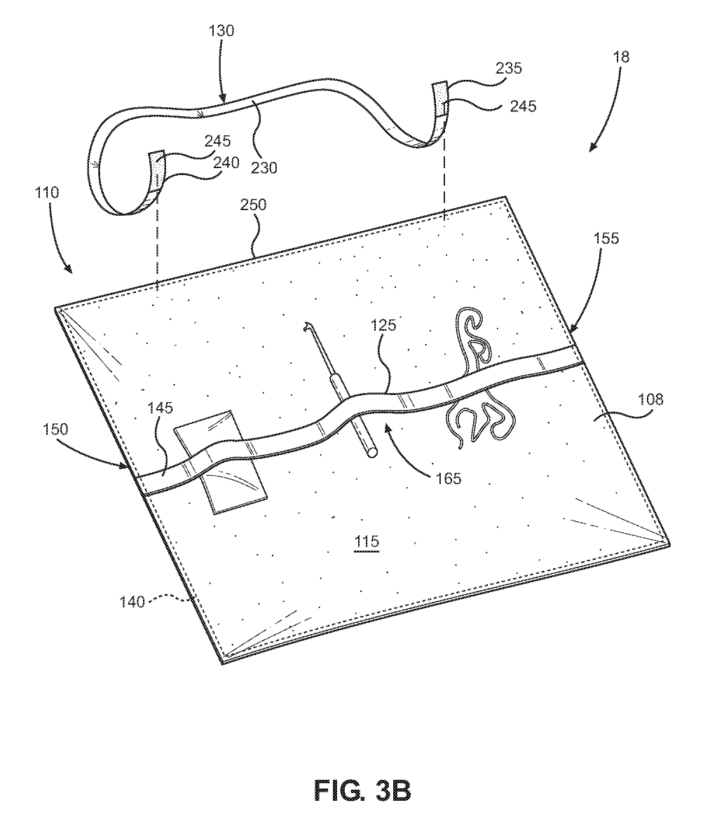

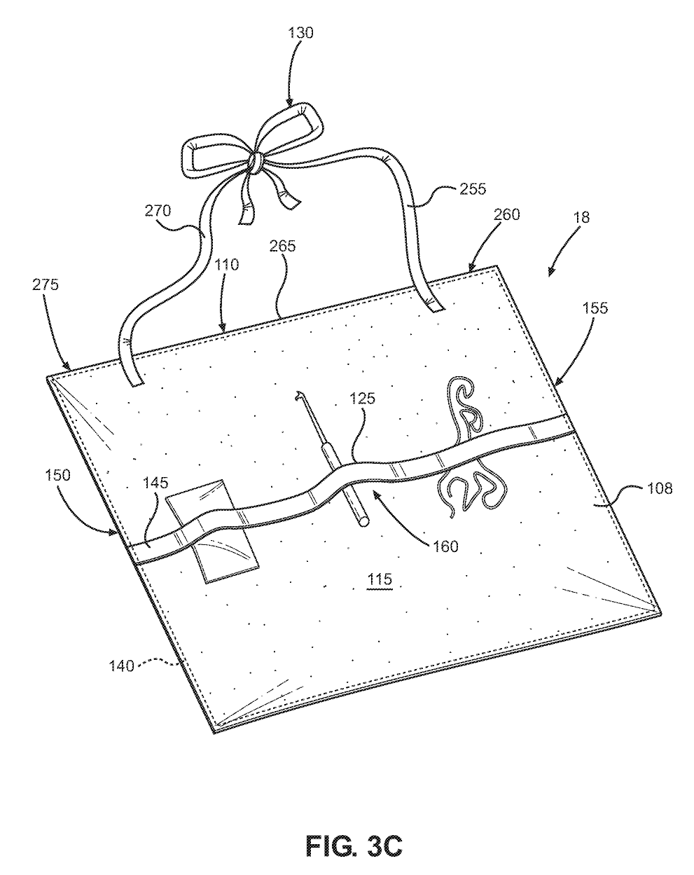

Referring now to FIGS. 3A-3C, there is shown a perspective view of the patient bib of the dental chair cover according to alternative embodiments of the present invention. The patient bib 18 comprises a flexible planar member 108 including an upper end 110, an upper surface 115, a lower surface 120, a plurality of slots 125 for removably receiving and retaining an item on the patient bib 18, and a strap 130 for removably securing the patient bib 18 around a patient's neck, as shown in FIG. 4. In the depicted embodiment, the patient bib 18 includes the same width and length of the cover body of the dental chair cover, such that it is coextensive with the cover body of the dental chair cover when removably affixed thereto. In the depicted embodiment, the patient bib 18 is composed of a paper material including a water-resistant plastic material 128, such as polyethylene, for absorbing and preventing the penetration and leakage of fluids through the patient bib 18.

The lower surface 120 of the patient bib 18 includes a lower perimeter edge 135 including an adhesive material 140 that is configured to removably secure the patient bib 18 to the upper surface of the cover body, as shown in FIG. 1. In this way, the dental chair cover kit 10 is configured to come together in one unit, in which the patient bib 18 may subsequently be separated from the cover body via the adhesive material 140 and re-attached to the cover body via the adhesive material 140. Additionally, the patient bib 18 may be removably secured to the garment of a patient on which it is secured when the dental chair cover kit is in use. In the depicted embodiment, the adhesive material 140 comprises an adhesive strip disposed about the lower perimeter edge 135 of the lower surface 120 of the patient bib 18.

In the depicted embodiment, the plurality of slots 125 are disposed on a laterally extending band 145 extending widthwise from a first side 150 of the patient bib 18 to an opposing second side 155 of the patient bib 18. Each of the plurality of slots 125 defines a longitudinal opening 160 configured to removably receive an item, such as dental tool, therethrough and retain the item therein. The plurality of slots 125 are spaced apart from each other at fixed intervals, so as to provide uniform spacing between items inserted therein.

In one embodiment, the strap 130 includes an elongated flexible member 165 having a first end 170 affixed to a first side 175 of an edge 180 of the upper end 110 of the patient bib 18 and a second end 185 affixed to an opposing second side 190 of the edge 180 of the upper end 110 of the patient bib 18, as shown in FIG. 1.

In another embodiment, the strap 130 includes an elongated flexible member 195 having a first end 200 affixed to a first side 205 of an edge 210 of the upper end 110 of the patient bib 18 and a second end 215 including an adhesive 220 for removably securing the second end 215 to an opposing second side 225 of the edge 210 of the patient bib 18, as shown in FIG. 3A.

In yet another embodiment, the strap 130 includes an elongated flexible member 230 including a first end 235 and a second end 240, each including an adhesive material 245 for removably securing the strap 130 to opposing sides of an edge 250 of the upper end 110 of the patient bib 18, as shown in FIG. 3B.

In an alternative embodiment, the strap 130 includes a first elongated flexible member 255 affixed to a first side 260 of an edge 265 of the upper end 110 of the patient bib 18 and a second elongated flexible member 270 affixed to an opposing second side 275 of the edge 265 of the upper end 110 of the patient bib 18, as shown in FIG. 3C.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A dental chair cover kit, comprising:
a dental chair cover including a body configured to cover an upper portion of a back rest of a dental chair, a pocket configured to receive a headrest of the dental chair therein, and an extendable neck member configured to enable extension of the body relative to the pocket;
the body including a planar flexible member including an upper end and an upper surface;
the pocket including a closed upper end, an open lower end, an upper surface, and an interior volume sized to receive the headrest of the dental chair, the open lower end including a perimeter edge defining an opening for providing access to the interior volume;
the extendable neck member interconnecting the upper end of the body to the open lower end of the pocket, the extendable neck member biased in a first position and extendable to a second position;
a bib removably affixed to the dental chair cover via an adhesive material, the bib including a flexible planar member including a strap for removably securing the bib to a user and an upper surface including a slot configured to removably receive and retain an item.

2) The dental chair cover kit of claim 1, wherein the upper surface of the body and the upper surface of the pocket are coplanar relative to each other along a longitudinal plane, such that the opening of the pocket is disposed offset and beneath the longitudinal plane.

3) The dental chair cover kit of claim 2, wherein the extendable neck member interconnects an edge of the upper end of the body to a perimeter edge of the open lower end of the pocket, such that the extendable neck member is coplanar with the upper surface of the body and the upper surface of the pocket.

4) The dental chair cover kit of claim 3, wherein the extendable neck member includes an accordion fold configured to collapse into the first position and extend into the second position.

5) The dental chair cover kit of claim 4, wherein the dental chair cover is composed of a paper material.

6) The dental chair cover kit of claim 1, wherein the adhesive material of the bib is disposed on a perimeter edge of a rear surface of the bib.

7) The dental chair cover kit of claim 1, wherein the bib includes a width equal to a width of the body of the dental chair cover and a length equal to a length of the body of the dental chair cover, such that the bib is coextensive with the body of the cover when removably affixed thereto.

8) The dental chair cover kit of claim 1, wherein the bib is composed of a water-resistant plastic material.

9) The dental chair cover kit of claim 1, wherein the strap includes an elongated flexible member having a first end affixed to an edge of an upper end of the bib and a second end including an adhesive for removably securing the second end to the bib.

10) The dental chair cover kit of claim 1, wherein the strap includes a first elongated flexible member affixed to a first side of an edge of an upper end of the bib and a second elongated flexible member affixed to an opposing second side of the edge of the upper end of the bib.

11) The dental chair cover kit of claim 1, wherein the strap includes an elongated flexible member including a first end and a second end, the first end and the second end including an adhesive material for removably securing the strap to the bib.

12) The dental chair of claim 1, wherein the bib includes a plurality of slots extending across a width of the bib, the plurality of slots spaced apart from each other at fixed intervals.

13) The dental chair cover kit of claim 12, wherein the plurality of slots are disposed on a band extending widthwise from a first side of the bib to an opposing second side of the bib.

14) A dental chair cover kit, comprising:
a dental chair cover including a body sized and configured to cover an upper portion of a back rest of a dental chair, a pocket configured to receive a headrest of the dental chair therein, and an extendable neck member configured to enable extension of the body relative to the pocket;
the body including a planar flexible member including an upper end and an upper surface;
the pocket including a closed upper end, an open lower end, an upper surface, and an interior volume sized to receive the headrest of the dental chair, the open lower end including a perimeter edge defining an opening for providing access to the interior volume;
the extendable neck member interconnecting the upper end of the body to the open lower end of the pocket, the extendable neck member biased in a first position and extendable to a second position.

15) The dental chair cover kit of claim 14, wherein the upper surface of the body and the upper surface of the pocket are coplanar relative to each other along a longitudinal plane, such that the opening of the pocket is disposed offset and beneath the longitudinal plane.

16) The dental chair cover kit of claim 15, wherein the extendable neck member interconnects an edge of the upper end of the body to a perimeter edge of the open lower end of the pocket, such that the extendable neck member is coplanar with the upper surface of the body and the upper surface of the pocket.

17) The dental chair cover kit of claim 16, wherein the extendable neck member includes an accordion fold configured to collapse into the first position and extend into the second position.

18) The dental chair cover kit of claim 17, wherein the dental chair cover is composed of a paper material.

19) A dental chair cover kit, comprising:
a bib including a flexible planar member including a strap for removably securing the bib to a user, an upper surface including a plurality of slots extending laterally across a width of the upper surface of the bib, and an adhesive material for removably attaching the bib to a surface;
the plurality of slots defining a longitudinal opening configured to removably receive an item therethrough and retain the item therein;
wherein the plurality of slots are spaced apart from each other at fixed intervals.

20) The dental chair cover kit of claim 19, wherein the adhesive material of the bib is disposed on a perimeter edge of a rear surface of the bib.

21) The dental chair cover kit of claim 19, wherein the strap includes an elongated flexible member having a first end affixed to an edge of an upper end of the bib and a second end including an adhesive for removably securing the second end to the bib.

22) The dental chair cover kit of claim 19, wherein the strap includes a first elongated flexible member affixed to a first side of an edge of an upper end of the bib and a second elongated flexible member affixed to an opposing second side of the edge of the upper end of the bib.

23) The dental chair cover kit of claim 19, wherein the strap includes an elongated flexible member including a first end and a second end, the first end and the second end including an adhesive material for removably securing the strap to the bib.
